(19) United States
(12) Patent Application Publication
(10) Pub. No.: US 2025/0213897 A1
(43) Pub. Date: Jul. 3, 2025

(54) Wide-Area Fire-Retardant System Using Distributed Dense Water Fogger

(71) Applicant: Jeff Johnson, San Francisco, CA (US)

(72) Inventor: Jeff Johnson, San Francisco, CA (US)

(21) Appl. No.: 19/082,958

(22) Filed: Mar. 18, 2025

Related U.S. Application Data
(63) Continuation-in-part of application No. 16/895,635, filed on Jun. 8, 2020.
(60) Provisional application No. 63/006,041, filed on Apr. 6, 2020.

(51) Int. Cl. A62C 3/02; A62C 37/36; G01W 1/00; G06N 3/006; H04W 84/18

(52) U.S. Cl. CPC A62C 3/0264; A62C 3/0271; A62C 37/36; G01W 1/00; G06N 3/006; H04W 84/18

(57) ABSTRACT

A wide-area fire-suppression system comprises geographically distributed wind sensors and fire-suppression devices. A computational method and apparatus provides for provisioning a plurality of independent agents, each of the plurality of independent agents associated with a fire-suppression device and configured to operate as a particle in a particle swarm optimization (PSO) implementation. A neighborhood is designated to comprise multiple ones of the plurality of independent agents. Communications are provided between the multiple ones of the plurality of independent agents. Each particle is then configured to optimize a droplet size to improve cooling at a target location, the droplet size being a function of the each particle's historical droplet size and at least one droplet size determined by at least one neighboring particle.

### CROSS REFERENCE TO PRIOR APPLICATIONS

This application is a continuation-in-part of U.S. patent application Ser. No. 16/895,635, filed on Jun. 8, 2020, which claims the priority benefit of United States Patent Provisional Application Ser. No. 63/006,041, filed on Apr. 6, 2020, each of which is expressly incorporated by reference in its entirety.

### BACKGROUND

### I. Field

The following relates to methods, systems, and devices for fighting wildfires and protecting assets from wildfires, and to provisioning and operating a geographically distributed network of sprayers.

### II. Background

The background description includes information that may be useful in understanding the present inventive subject matter. It is not an admission that any of the information provided herein is prior art or relevant to the presently claimed inventive subject matter, or that any publication, specifically or implicitly referenced, is prior art.

Traditional fire suppression systems typically employ fixed sprinkler grids or individual fire suppression devices that operate independently based on localized sensor data. These systems often lack the ability to dynamically coordinate and adapt to changing environmental conditions, such as shifting wind patterns or uneven fire spread.

Existing approaches to fire suppression lack mechanisms for real-time coordination among multiple fire suppression devices and fail to leverage distributed optimization techniques to improve system performance. In particular, there is a need for a system where fire suppression devices can adapt their behavior in response to neighboring devices and environmental conditions to maximize the cooling effect at a target location.

### SUMMARY

In an exemplary, but non-limiting, application of some aspects disclosed herein, homes, businesses, neighborhoods, or towns in areas that are at risk of wildfires can be protected by a wildfire-prevention infrastructure that comprises water sources, pipes, and high-pressure cold water mist generators. The mist generators could be placed around and/or outside a protection area's perimeter, along the likely approach path of a wildfire, and/or throughout the area, including around and on buildings. In some aspects, this distributed infrastructure need not entirely surround the protected area, because the likely direction of approach of wildfires is often known based on expected wind directions and the location of combustible material. The mist generators could be activated remotely, or triggered automatically when an approaching fire reaches detectors located around a protected area.

In some aspects, a wide-area fire-suppression system is laid out in a grid, and each zone in the grid has at least one spray head. By exploiting the wind to carry water droplets to a target, spray heads in many zones can be configured to service a target outside of their zones. Since smaller droplets have a greater cooling effect and conserve water better, spray heads that are farthest away from the fire might be configured to produce the smallest droplets, which provides a fire suppression strategy that is more effective at extinguishing the fire.

Disclosed aspects can provision advanced situational awareness for wind conditions, such as a model of the windspeed and direction along the entire path between each spray head and the target. Situational awareness is the ability to perceive, understand, and effectively respond to one's situation. It can involve comprehending a given circumstance, gathering relevant information, analyzing it, and making informed decisions. Advanced situational awareness can include the ability to perceive, understand, and effectively respond to at least one other's situations; or perceiving one's situation with the aid of at least one other's situational awareness. Thus, advanced situational awareness disclosed herein can comprise cooperation among multiple devices, which can comprise sharing of information, data fusion, and may include a consensus-based decision-making process. Advanced situational awareness can be used to enable spray head control to be more responsive to environmental conditions, and thus, provide spray features (such as a selectable droplet size) that improve the cooling effect at the target and use less water.

Since a fire-suppression problem has well-defined inputs and outputs, and is data-driven, some solutions can employ distributed machine learning or artificial intelligence (AI), which may perform a combination of supervised and unsupervised learning, and which might self-organize into clusters of AI agents that can implement swarm intelligence. It should be appreciated that disclosed aspects can be configured for any decentralized computing and/or data management, such as Cloud computing, Fog computing, edge computing, Cloud storage, or the like.

In some instances, each of a set of AI agents associated with a different spray head determines whether its spray head can provide a sufficient cooling effect at a target location, such as by comparing an estimated cooling effect to a threshold value or by computing a wind-path vector. Thus, by determining active spray heads, the AI agents can self-organize into one or more clusters. This can reduce the computational complexity, latency, and the amount of sensor data that needs to be processed in real time, while responding to a fire event compared to centralized control.

In some aspects, different clusters of AI agents can teach each other which strategies produce the best results. In one example, particle swarm optimization (PSO) enables AI agents to indirectly learn from each other. Some aspects might employ “transfer learning” in which a pre-trained neural network's knowledge is used as a starting point for training a new network on a related task. In some aspects, an executive system's output might be employed as ground truths, thus providing for reinforcement learning. Neural networks disclosed herein might be configured to perform any of various types of machine learning or artificial intelligence.

In one aspect, method and apparatus aspects are configured for provisioning a plurality of independent agents, each of the plurality of independent agents associated with a fire-suppression device and configured to operate as a particle in a PSO implementation. At least one neighborhood is defined such that each neighborhood comprises multiple ones of the plurality of independent agents. Communication is provided between the multiple ones of the plurality of independent agents, such as via any suitable wireless communication technology. Each particle is configured to optimize a droplet size to maximize cooling at a target location. The droplet size determined by a particle is a function of the particle's historical droplet size and at least one droplet size determined by at least one neighboring particle.

In one aspect, an apparatus comprises a network of fire-suppression devices distributed across a geographical area, each of the fire-suppression devices comprising a controller configured to adjust fluid droplet size. A network of wind sensors is configured for measuring windspeed and direction at multiple locations throughout the geographical area. A network of fire-detection sensors is configured to detect at least one of heat or fire. At least one computer processor is communicatively coupled to the network of fire-suppression devices, the network of wind sensors, and the network of fire-detection sensors; and is configured to compute a wind-path vector from each of a plurality of the fire-suppression devices to at least one geographical location of detected heat or fire. The wind-path vector can be computed from a plurality of the wind sensors in a path from the each of a plurality of the fire-suppression devices to the at least one geographical location. From the wind-path vector, a corresponding fluid droplet size for each of the plurality of the fire-suppression devices is computed to improve cooling at the at least one geographical location. Each of the plurality of the fire-suppression devices is adjusted to produce a spray comprising the corresponding fluid droplet size.

With respect to any of the apparatus aspects disclosed herein, related methods might include training at least one machine-learning program that operates the at least one computer processor, tuning the at least one machine-learning program, testing the at least one machine-learning program, validating the at least one machine-learning program, updating the at least one machine-learning program, manufacturing the components of the apparatus, assembling the components of the apparatus, or operating the apparatus.

With respect to any of the method aspects disclosed herein, a related apparatus might comprise circuitry, such as application specific integrated circuits (ASICs), computer processing units (CPUs), field programmable gate arrays (FPGAs), graphics processing units (GPUs), digital signal processors (DSP), other programmable logic devices (PLDs), discrete gate or transistor logic devices, discrete hardware components, or any combination thereof. Similarly, a related apparatus aspect might comprise a non-transitory computer-readable memory with instructions to configure at least one processor to perform any of the disclosed methods or steps therein.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. A user interface (e.g., keypad, display, mouse, joystick, etc.) may also be connected to the bus and/or communicatively coupled via the network adaptor. The bus may also link various other circuits, such as timing sources, peripherals, voltage regulators, power management circuits, and the like. The disclosed processor(s) may be implemented with one or more general-purpose and/or special-purpose processors. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor, such as with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Some disclosed aspects provide specific improvements in computer capabilities, particularly improvements to computer functionality itself. For example, some aspects augment or replace a physics-based model with a surrogate model to estimate a cooling at a target location, wherein the surrogate model enables a computer processor to accurately compute the cooling faster than the physics-based model, thus reducing the response time of the fire-suppression system. Such aspects replace physics-based computation with a neural network implementation.

Disclosed methods, non-transitory computer-readable memory with instructions to configure a processor to function in a prescribed manner, and such processor-plus-memory configurations provide for improving the operation of the computer processor itself. For example, operating such computer systems in a decentralized manner (e.g., using particle swarm optimization, swarm intelligence, artificial intelligence agents, intelligent agents, or the like), which involves distributing decision-making across autonomous fire-suppression devices, can enable each device to function as an intelligent agent, collaborating with neighbors to optimize a cooling effect at a predetermined location while adhering to water usage constraints. Such decentralized decision-making typically converges to an accurate decision much faster than centralized decision-making (as with a centralized processor), and usually with less communication overhead. Furthermore, some disclosed aspects might comprise non-conventional and non-generic arrangements of known, conventional parts.

Disclosed aspects relate to interacting with the tangible universe, such as by producing mist or fog with measurable properties (e.g., cooling effect), employing collected sensor data for configuring operating controls of spray heads to adapt properties of the spray they produce, and/or providing for cooling or fire suppression effects at a target location. The process of converting water to fog or mist, particularly with respect to prescribed properties (such as droplet size, elevation angle, azimuth angle, fluid pressure, and/or spray pattern), constitutes a transformation of matter. Converting a liquid suppressant into fine mist or aerosol that absorbs heat or smothers flames would constitute a transformation of the suppressant itself. By improving cooling, i.e., extracting heat from the environment, disclosed aspects more effectively transform thermal energy into a lower-energy state, which is a physical transformation. Accordingly, disclosed aspects that produce a cooling effect at a target location provide a useful, concrete, and tangible result. Furthermore, by reducing the temperature or changing the chemical composition of the fire environment (e.g., lowering oxygen levels or introducing fire-retardant chemicals), is a transformation of the environment into a different physical state.

In one aspect, a method comprises collecting wind data; using the wind data and each of a set of different droplet sizes, computing a set of cooling effect contours of a spray; selecting a one of the set of cooling effect contours that provides an optimal cooling effect at a geographical location; and configuring a spray head to produce a droplet size corresponding to the one of the set of cooling effect contours.

In another aspect, a method comprises collecting wind data in a path from each of a plurality of spray heads to at least one geographical area; using the wind data and each of a set of different droplet sizes, computing a set of cooling effect contours of a spray for each of the plurality of spray heads; from the set of cooling effect contours, selecting an optimal set of cooling effect contours that provides an optimal cooling effect at the at least one geographical location; and configuring each of the plurality of spray heads to produce a droplet size corresponding to its corresponding one of the optimal set of cooling effect contours.

In another aspect, an apparatus comprises a network of fire-suppression devices distributed across a geographical area, each of the fire-suppression devices comprising a controller configured to adjust fluid droplet size. A network of wind sensors is configured for measuring windspeed and direction at multiple locations throughout the geographical area. At least one processor is configured to compute a wind vector from each of a plurality of the fire-suppression devices to at least one target location in the geographical area, compute droplet sizes for each of the plurality of the fire-suppression devices, determine constraints based on water availability and determine estimated cooling effects as a function of the droplet sizes and wind-path vectors. Then the at least one processor selects a set of the plurality of the fire-suppression devices that optimizes the estimated cooling effect within the constraints.

It should be appreciated that the term “optimize” or related terminology, as used anywhere in the disclosure, means “best” or “preferred” among a finite plurality of options, such as estimates, measurements, or the like. An optimized cooling effect (such as may be estimated or measured at a target location) means a maximum reduction in temperature, a minimum temperature, a maximum evaporative cooling, or the like, among a finite plurality of possible cooling effects. Where the term “optimize” or related terminology is used in this disclosure, it should be appreciated that alternative aspects might seek to “improve” (e.g., the cooling effect). For example, the cooling effect can be improved, which can mean reducing the temperature, increasing the evaporative cooling, or the like at a target location.

In another aspect, a method comprises aggregating data from multiple wind sensors to model windspeed and direction along an entire path between each of a plurality of spray heads and a target. This can be done to compute a wind-path vector. Based on the wind-path vector, a droplet size can be computed for each of the plurality of spray heads to maximize a cooling effect at the target. Each of the plurality of spray heads is configured to produce a spray having the computed droplet size.

In another aspect, an apparatus comprises a neural network configured to adapt its network parameters for provisioning a set of control signals in a distributed fire-suppression system. The network parameters are configured to produce a set of expectation values for sensor measurements, and the neural network generates an error estimate as a function of the expectation values and measured sensor values. The neural network is tuned by updating its network parameters in a manner that reduces the error estimate. In some aspects, upon reducing the error estimate below a predetermined threshold, the network parameters might be adapted to effect a predetermined set of measured sensor values.

In another aspect, a method comprises training a first neural network to predict a cooling effect for input data comprising sprayer control parameters in a distributed fire-suppression system; and training a second neural network for adapting the input data to the first neural network; wherein adapting comprises updating the second neural network's network parameters in a manner that improves the cooling effect predicted by the first neural network.

Methods and devices operable in a fire-suppression system disclosed herein can comprise provisioning a plurality of artificial neural networks, each of the plurality of artificial neural networks configured to compute a droplet size for at least one spray head that improves a cooling effect at a target location; configuring the plurality of artificial neural networks to have a diversity of operating characteristics; provisioning an executive system to combine droplet-size decisions produced by the plurality of artificial neural networks to generate a combined droplet-size decision therefrom; and adapting the at least one spray head to produce a spray having a droplet size based on the combined droplet-size decision.

Methods, steps, blocks, and/or functional aspects disclosed herein should be understood as including corresponding structural features, such as apparatuses, apparatus components, devices, systems, circuits, processors, and/or non-transitory computer-readable media with software or firmware stored thereon and configured to instruct at least one processor to perform any of the methods, steps, blocks, and/or functional aspects.

Incorporation by reference, as used herein, is intended to be interpreted under 37 CFR 1.57 and MPEP 2163.07 (b), and not ignored or disregarded. Instead of repeating information contained in another document, this disclosure incorporates the content of the noted documents by reference to those documents. The information incorporated is as much a part of this disclosure as if the text was repeated in the disclosure, and should be treated as part of the text of the disclosure. Since incorporation by reference has the same effect as if the host patent had set forth the entire text of the incorporated document, the skilled artisan is instructed to regard some aspects as constituting a conversion of any invention in the instant written description into any invention disclosed in the incorporated patent. The skilled artisan is also instructed to regard some aspects as constituting a conversion of any invention disclosed in the incorporated patent into any invention in the instant written description.

Terminology presented herein should be interpreted according to definitions in general-purpose dictionaries to aid the skilled artisan in understanding the invention. Terminology in the claims should be interpreted with respect to both intrinsic and extrinsic evidence. In the case of multiple-word terms, their meaning can be understood with reference to each individual word's plain and ordinary meaning, as might be found in a general-purpose dictionary, combined with the concepts in this disclosure and/or the related art. In some instances, the technical nature intended to be expressed by terminology might diverge from its plain and ordinary meaning. In such cases, terminology in the disclosure might attempt to capture the spirit and effect of mathematical concepts, such as (but not limited to) mathematical equations, properties, relationships, principles, laws, axioms, postulates, rules, lemmas, theorems, propositions, corollaries, generalizations, identities, and/or the like. Such terminology should be interpreted with respect to the corresponding mathematical concept(s).

### BRIEF DESCRIPTION OF THE DRAWINGS

A further understanding of the nature and advantages of the present disclosure may be realized by reference to the following drawings. In the appended figures, similar components or features may have the same reference label. Flow charts depicting disclosed methods comprise “processing blocks”, “elements”, or “steps” that may represent computer software instructions or groups of instructions. Alternatively, the processing blocks or steps may represent steps performed by functionally equivalent circuits, such as a digital signal processor or an application specific integrated circuit (ASIC). It will be appreciated by those of ordinary skill in the art that unless otherwise indicated herein, the particular sequence of steps described is illustrative only and can be varied. Unless otherwise stated, the steps described below are unordered, meaning that the steps can be performed in any convenient or desirable order.

FIG. 1A depicts a set of cooling effect contours across a geographical area downwind of a sprayer head. Each contour corresponds to a different droplet size.

FIG. 1B illustrates distributions of droplet sizes, each distribution corresponding to one of the contours in FIG. 1A.

FIG. 1C is a contour plot illustrating a cooling effect corresponding to relative location (e.g., distance) of a target position (depicted by the “X” axis) for different mean values of droplet size (depicted by the “Y” axis).

FIGS. 2A-2C each illustrates a flow diagram of methods and/or functional aspects of fire-suppression system according to some disclosed aspects.

FIG. 2D is a block diagram of a spray head apparatus corresponding to some disclosed aspects.

FIG. 3A illustrates a network of spray heads distributed across a geographical area.

FIG. 3B illustrates a wind-path vector through a geographical area that is computed from wind data. The wind-path vector can comprise segments indicating windspeed and direction in two or three dimensions.

FIG. 4 depicts a network of fire-suppression devices in accordance with some disclosed aspects. By way of example, in a decentralized network of processors, each processor may be associated with a spray head. Using wind data and the location of a target area as inputs, each processor can compute a set of spray patterns for different spray-head control parameters and select a best spray pattern that provides a desired cooling effect at the target area, possibly as a function of predetermined constraints (such as amount of water used).

FIGS. 5A-5D each depicts a wildfire suppression method in accordance with disclosed aspects.

FIGS. 6A and 6B each illustrates methods or functional features of an apparatus configured to operate according to some aspects of the disclosure.

### DETAILED DESCRIPTION

Various aspects of the disclosure are described below. It should be apparent that the teachings herein may be embodied in a wide variety of forms and that any specific structure, function, or both being disclosed herein are merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

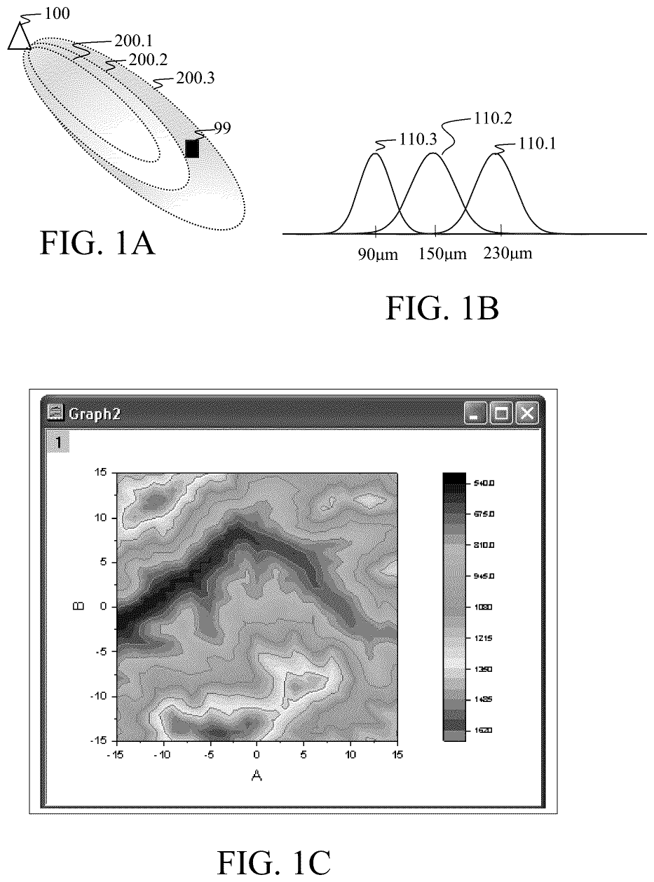

FIG. 1A depicts a set of cooling effect contours 200.1-200.2 across a geographical area downwind of a spray head 100 and corresponding to different droplet sizes for a given wind profile. Darker shading in each contour represents a greater cooling effect. The cooling effect might be quantified as a computed amount of heat absorbed to raise the droplet temperature from its initial state to the boiling or evaporation point, the heat absorbed when the water droplets evaporate at a surface or in the air, an estimated change in air temperature, an estimated change in surface temperature, or any combination thereof. In one example, the total cooling effect at the target location combines the sensible heat absorption, latent heat absorption, and convective cooling.

Various spray head adjustments can adjust the cooling effect. The cooling effect is fundamentally driven by the heat exchange that occurs when the droplets absorb heat from the target location and evaporate. Larger droplets have higher momentum and can penetrate deeper into a fire or hot zone, increasing direct surface cooling. Smaller droplets tend to stay suspended longer, providing more evaporative cooling in the air. If the spray head can vary the droplet velocity, higher velocity droplets can increase convective heat transfer upon impact with a surface.

Contour sizes and shapes are influenced by wind conditions and topography (such as might be expressed by the characterization of windspeed and direction across physical features of a landscape), and the contours can be adapted via selection of droplet sizes, sprayer elevation angle, and spray pattern. By way of example, a target area 99 may be designated, and the sprayer head 100 can be adapted, such as relative to the wind conditions and topography, to maximize cooling effect at the target 99. For example, the sprayer head 100 can be adapted to exploit the windspeed and direction to deliver a fog to a target area that is outside of the grid section, zone, or region in which it is positioned. Specifically, the sprayer head 100 can be adapted to exploit wind to increase (e.g., optimize) the cooling effect in a target location that is outside of its grid section, zone, or region, possibly far downwind from its location. The sprayer head 100 might be one of a set of geographically distributed sprayer heads configured to cooperate in implementing fire-suppression strategies.

FIG. 1B illustrates distributions of droplet sizes 110.1-110.3, each corresponding to one of the contours 200.1-200.3, respectively. In addition to the mean droplet size being selectable, the sprayer head 100 may be adapted to control the distribution of droplet sizes around the mean. In response to topography and measured and/or predicted wind conditions, by selecting one or more droplet-size configurations, each sprayer head, or groups of sprayer heads, can produce an improved or optimal cooling effect contour that achieves a desired cooling effect criterion. Spray pattern selection, such as pattern shape, azimuth angle, elevation angle, water pressure, and/or other spray pattern characteristics, may be adapted with respect to topography and/or wind conditions to achieve a predetermined cooling effect criterion.

In some instances, droplet sizes might be selectable with respect to spray pattern selection, such as pattern shape, azimuth angle, elevation angle, water pressure, and/or other spray pattern characteristics. Droplet-size distributions might be configured with respect to the pattern shape, azimuth angle, and/or elevation angle, for example. This might be done to exploit wind dispersion to deliver droplets to particular geographical locations and produce desirable cooling effect contours. Accordingly, droplet size distributions might be adapted to vary across the azimuth angle and/or elevation angle of each spray pattern in a manner that exploits the dispersion effects of the topography and wind conditions to effect a desired cooling contour. Thus, dispersion conditions can characterize measurements or predictions of the ability of the wind to dilute airborne particles (e.g., droplets, fogs, vapors). The dispersion includes both horizontal and vertical dilution of released vapor-like particulates.

FIG. 1C is a contour plot illustrating a cooling effect corresponding to relative location of a target position (e.g., 99), depicted by the “X” axis, for different mean values of droplet size, depicted by the “Y” axis. Due to the complexity of physics-based models (e.g., computational fluid dynamics for droplet dispersion, evaporation, and cooling in complex topographies), it can be advantageous in some aspects to augment or replace a physics-based model with a surrogate model, such via a neural network implementation.

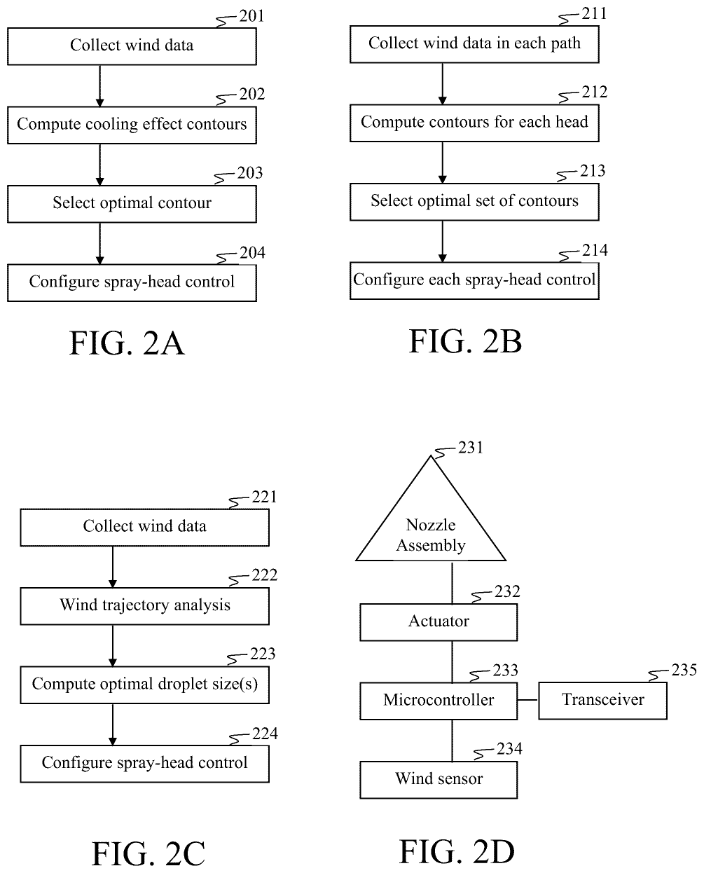

FIG. 2A illustrates a flow diagram that can indicate methods and/or functional aspects of disclosed fire-suppression systems. In one example, wind data is collected 201 from a network of sensors distributed across a geographical area. Using the wind data and each of a set of different droplet sizes, a set of cooling effect contours, as may result from spray patterns, is computed 202. Specifically, a network of spray heads can be provisioned across the geographical area. Each cooling effect contour might correspond to a different spray head or a group of spray heads. In addition to droplet size (i.e., droplet size can refer to a distribution of droplet sizes or a median droplet size), other sprayer controls can be configured to provision cooling effect contours, such as water pressure, sprayer elevation, sprayer elevation angle, sprayer azimuth angle, spray-pattern shape, etc.

At least a one of the set of cooling effect contours determined to provide a desired (e.g., an optimal) cooling effect at a geographical location is selected 203. Each spray head is then configured 204 to produce a droplet size corresponding to the one of the set of cooling effect contours. Each spray head might comprise valves, baffles, selectable spray heads, and the like, which are controllable to adjust the aforementioned parameters. A sprayer head control system communicatively coupled to each spray head might adapt flow rate, droplet size, spray pattern, spray direction, acration, and/or possibly other parameters to create a fog with desired properties in at least one geographical area of interest.

FIG. 2B illustrates a flow diagram that can indicate methods and/or functional aspects of disclosed fire-suppression systems. In one example, wind data is collected 211 from a network of sensors distributed across a geographical area. Specifically, wind data might be collected from sensors that are in a path from each of a plurality of spray heads to at least one geographical area of interest (e.g., a target). At least one wind-path vector might be computed from the wind data to characterize wind conditions along a path from each of at least some of the spray heads to the at least one geographical area. This might be done by selecting wind data collected from selected sensors along the path and aggregating the selected wind data to determine its corresponding wind-path vector. In one example, a wind-path vector might be computed as a vector sum of a plurality of wind vectors. In some instances, interpolation may be performed between data points, such as to provide for a higher-resolution wind-path vector.

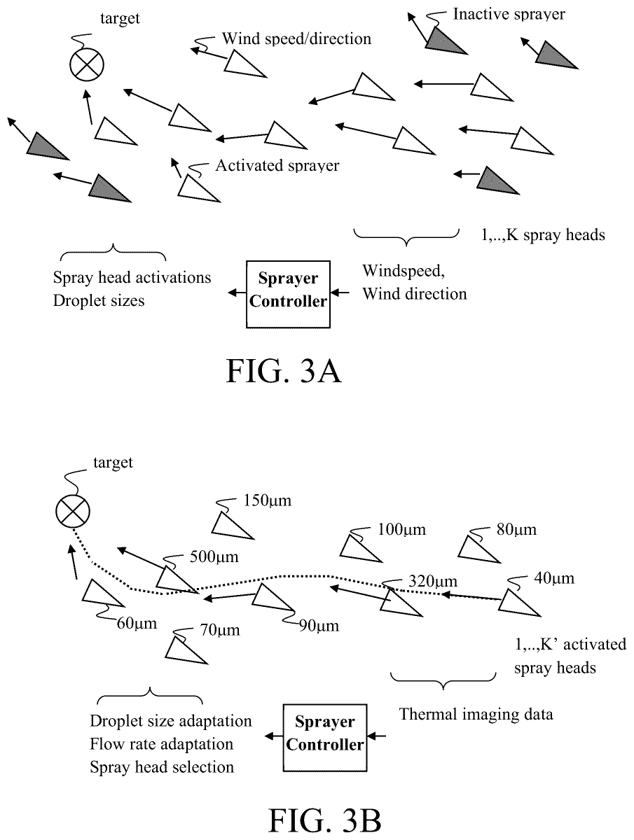

By way of example, FIG. 3A illustrates a network of spray heads, each of which might include a wind sensor to provide windspeed and direction, thus providing a network of wind sensors distributed across a geographical area. A vector depicting windspeed and direction is shown for each spray head. The wind data is processed by a centralized or distributed processor (or some combination thereof) configured to operate as a spray head controller. Based on wind data and at least one location (e.g., a target) of interest, the spray head controller can activate certain ones of the spray heads, select droplet sizes, and possibly adapt other control features of the spray heads. Inactive sprayers are depicted as shaded.

By way of example, FIG. 3B illustrates a wind-path vector that is computed from the wind data and leading to the target. The wind-path vector might comprise segments indicating windspeed and direction throughout a geographical area and might comprise three dimensions. Such a wind-path vector might be computed by selecting wind data from sensors between at least one spray head and the target(s), and aggregating the selected wind data. The wind-path vector might comprise a probability distribution of windspeed and direction. Similarly, contours or spray patterns might be indicated by probability density functions. Wind-path vectors and/or contours might be computed by integrating such probability distributions over a predetermined time interval. It should be appreciated that the wind-path vector might comprise a wind topography, a wind map, a wind profile, or the like. Wind profiles might contain yaw and pitch. If the yaw angle is variable, spiral-shaped wind profiles can result. The wind-path vector might be configured to comprise flow characteristics of wind passing over topographical features. In some aspects, weather prediction models might be employed.

In some aspects, machine learning, such as deep learning, might be employed to characterize or predict wind fields in complex terrain. Deep learning is a subset of machine learning and artificial intelligence that uses multi-layered neural networks. Commonly used deep neural network techniques for unsupervised or generative learning include Generative Adversarial Network (GAN), Autoencoder (AE), Restricted Boltzmann Machine (RBM), Self-Organizing Map (SOM), and Deep Belief Network (DBN) along with their variants.

In an artificial neural network implementation, ground truths might be derived from temperature (and/or fire-detection) sensor measurements, weather prediction models (e.g., a physics-based model), and/or an executive system's output. Spray heads within a predetermined or dynamically determined vicinity of the wind-path vector might be selectable for activation. Based on the wind-path vector, an optimal droplet size might be selected for each spray head.

Referring back to FIG. 2B, using the wind-path vector and each of a set of different droplet sizes, a set of cooling effect contours of a spray for each of the plurality of spray heads might be computed 212. From the set of cooling effect contours, an optimal set of cooling effect contours that provides an optimal cooling effect at the at least one geographical location is selected 213. Each of the spray heads is then configured 214 to produce a droplet size corresponding to its corresponding one of the optimal set of cooling effect contours.

In one aspect, a system comprises a network of intelligent spray heads, possibly arranged in a grid, cach equipped with sensors to measure local wind conditions, and actuators to control droplet size, release angle, and possibly other spray-head operating features. A centralized or distributed control unit might process wind data, fire location, and system constraints to dynamically optimize the fire-suppression effort.

In a distributed network of wind sensors, fire sensors, and spray heads, the centralized and/or distributed control can dynamically form virtual network topologies to optimize communication and decision-making in response to a particular fire event. In one aspect, all nodes (sensors, spray heads, and processors) initially form a mesh network wherein routing tables are populated to define default paths for data transmission. Upon detection of a fire event, nodes in proximity to the fire might be designated as priority nodes for the purpose of prioritizing their network access. Wind sensors in close proximity to the fire zone might increase their data reporting rate to improve real-time situational awareness. The network might reconfigure itself using a dynamic routing protocol (e.g., OSPF, AODV) to create virtual links between the nodes and centralized and/or distributed control processors. Nodes might self-organize into a clustered topology, wherein selected sensors cluster together to reduce communication latency, and nodes relay data along the shortest, lowest-latency paths. The network might assign a Quality of Service (QOS) priority level to different data types and/or different sensors and spray heads relative to wind conditions and proximity to the fire. The network nodes might be configured to self-organize to perform adaptive multi-hop routing, such as to provide for fault tolerance and self-healing. In one example, self-healing mesh protocols, such as Zigbee, Thread, or BLE Mesh might be employed to enable automatic rerouting and fault tolerance. In some instances, Software-Defined Networking (SDN) allows centralized control over routing, QoS, and node activation. Machine-learning models can anticipate how the fire will spread and adjust the network configuration accordingly.

The disclosed distributed network of sensors and actuator/sprayers offers significant advantages in terms of robustness and resilience against the failure of individual components, especially in the challenging and unpredictable environment of a wildfire. Wildfires present a dynamic environment in which high temperatures, falling debris, and structural collapse can disable or destroy individual system components. The distributed systems disclosed herein can maintain functionality and continue to provide effective fire suppression, even when some components are damaged or lost.

In accordance with aspects disclosed herein, redundancy is provisioned in the system design. When a sensor or sprayer is damaged or destroyed, neighboring components can adjust their coverage or increase their activity to compensate for the loss. The network can dynamically reconfigure itself to reroute data and control signals around failed nodes, ensuring continuity of communication and operation. If a fire sensor or wind sensor is destroyed, nearby sensors can increase their reporting frequency to provide compensatory situational awareness. If a spray head is damaged, neighboring spray heads might adjust their droplet size and/or spray pattern to cover the affected zone.

Certain advantageous features will be appreciated as a result of implementing decentralized, as opposed to centralized, control. In some aspects, independent agents (e.g., sensors and spray heads) make local decisions based on available data. In disclosed systems that employ centralized control, decentralized control may be provided. Thus, if communication with a central decision-support processor is lost, local nodes can operate autonomously using peer-to-peer communication and historical data. For example, PSO enables agents to adapt based on local inputs, improving responsiveness even when centralized guidance is unavailable. If the central processor is taken offline due to fire damage, local agents can operate in a decentralized mode, adjusting spray patterns and droplet sizes based on local wind conditions and fire sensor data.

Disclosed networks can employ a self-healing mechanism in which the network topology can adapt to node failures. For example, failed nodes can be automatically removed from the routing table, new shortest-path routes may be computed dynamically, and nodes may form new clusters to maintain connectivity and operational integrity. If communication links are lost, the remaining network nodes can reroute communications through intact nodes, re-establishing a functional topology.

In some aspects, the geographic distribution of sensors and spray heads is configured to provide for spatial diversity, which reduces the likelihood that a single localized fire event will compromise the entire system. The network can dynamically redistribute loads to unaffected zones to maintain system-wide balance and efficiency. For example, if a cluster of spray heads is overwhelmed or disabled in a high-intensity fire zone, adjacent spray heads can increase their coverage. The remaining spray heads can optimize their spray pattern and/or droplet size, such as via PSO, to maintain nearly the same cooling effect at the target location. Such a system is designed to degrade gracefully rather than catastrophically, as the performance remains acceptable due to adaptive reallocation of resources and rerouting of communications.

Disclosed aspects provide for decentralized situational awareness and low-latency real-time adjustment. Sensors continuously monitor environmental conditions (e.g., wind, temperature, humidity, smoke, and/or fire) and provide feedback that is used to adjust the system in real time. The PSO framework can be configured to enable distributed optimization based on rapidly changing conditions, improving resilience against environmental fluctuations. For example, if wind direction suddenly changes due to fire-generated turbulence, nearby wind sensors detect the shift and update spray head trajectories and droplet sizes within seconds.

FIG. 2C illustrates a flow diagram that can indicate methods and/or functional aspects of disclosed fire-suppression systems. In one example, wind data might be collected 221 from a network of wind sensors distributed across a geographical area. Overall, the system incorporates sensors to measure wind speed and direction throughout a protected area. In one aspect, each of a set of devices collects local wind data. A device might poll wind sensors and/or other devices to collect wind data in a path to a target or geographical area of interest. In some instances, a fire-detection network might be employed, using thermal imaging, smoke sensors, etc., and the devices might employ such information to determine the target or geographical area of interest.

Each device performs 222 wind trajectory analysis. A computational model evaluates wind conditions along the entire path from each spray head to the fire. By modeling the airflow, the system can predict where droplets of different sizes will land. From this prediction, the system can compute 223 an optimal droplet size and configure 224 the spray heads accordingly. Thus, multiple spray heads from different zones can work in coordination to target a fire, adjusting their spray patterns and droplet sizes accordingly. Smaller droplets, which provide greater evaporative cooling, are deployed from spray heads positioned farther from the fire, while larger droplets might be used for direct fire suppression.

In some instances, selecting which sprayer heads to activate and/or selecting droplet sizes can be performed with the objective of ensuring efficient use of water resources by directing only the necessary amount of water to the fire, reducing waste and increasing sustainability. Thus, in one example, the fire suppression strategy prioritizes smaller droplets from farther spray heads to leverage wind transport for enhanced cooling at the target fire location. In some instances, spray heads (such as spray heads along a path to a fire) might communicate with each other, such as to exchange sensor data and/or operating parameters (e.g., droplet size and/or other control parameters) for developing effective fire suppression strategies. The system can continuously update calculations based on changing wind conditions to maintain optimal fire suppression effectiveness.

FIG. 2D is a block diagram of a spray head apparatus corresponding to some disclosed aspects. A nozzle assembly 231 might comprise multiple nozzle configurations to optimize a spray pattern for different wind conditions and can comprise a variable aperture nozzle that can dynamically adjust the droplet size. An actuator 232 can comprise a motorized adjustment system that modifies the nozzle spray pattern, droplet size, and/or droplet release rate. A microcontroller 233 adjusts spray parameters accordingly. A wind sensor 234 detects local wind speed and direction. A transceiver 235, such as a wireless communication system, can communicate with other spray head apparatus, a central controller, and/or sensors. Each spray head might operate as an intelligent agent, adjusting its output based on local conditions and input from neighboring spray heads. In some disclosed aspects, a distributed algorithm based on particle swarm optimization (PSO) can allow the system to iteratively refine water dispersion strategies in real time.

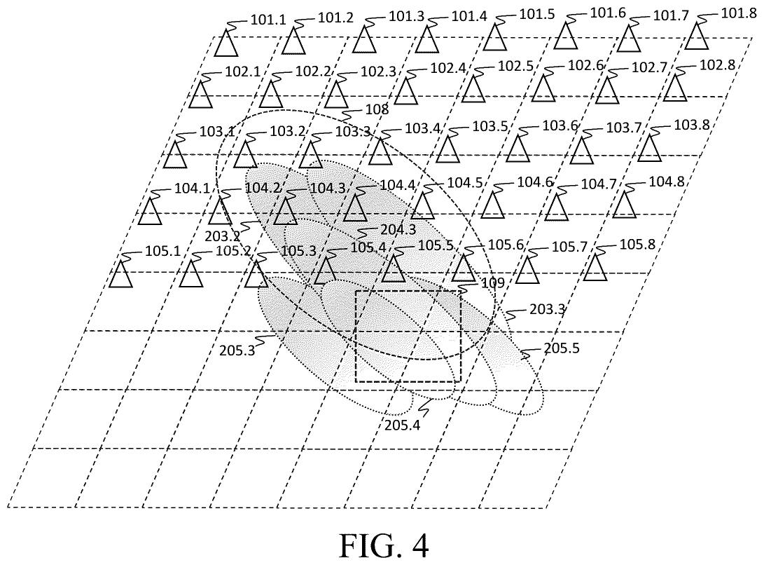

In FIG. 4, a network of fire-suppression devices (e.g., spray heads 101.1-101.8, 102.1-102.8, 103.1-103.8, 104.1-104.8, 105.1-105.8) are distributed across a geographical area, each of the fire-suppression devices comprising a controller configured to adjust fluid droplet size. A network of wind sensors (not shown, but may be integrated into at least some of the fire-suppression devices) is configured for measuring windspeed and direction at multiple locations throughout the geographical area. At least one processor (e.g., integrated into at least some of the fire-suppression devices, and/or in a central processor) is configured to compute wind vectors from each of a plurality of the fire-suppression devices to at least one target location 109 in the geographical area, compute droplet sizes for each of the plurality of the fire-suppression devices, determine constraints based on water availability or water conservation criteria, and determine estimated cooling effects as a function of the droplet sizes and wind vectors, and select a set of the plurality of the fire-suppression devices that optimizes the estimated cooling effect within the constraints.

In one example, cooling effect contours 203.1, 203. 204.3, 205.3, 205.4, and 205.5 corresponding to fire-suppression devices 103.1, 103. 104.3, 105.3, 105.4, and 105.5, respectively, can be computed. Each cooling effect contour (203.1, 203. 204.3, 205.3, 205.4, and 205.5) might be optimized via selection of droplet sizes to provide maximum cooling at the target 109. Specific ones of the fire-suppression devices 103.1, 103. 104.3, 105.3, 105.4, and 105.5 can be selected to optimize the cooling within predetermined constraints, such as water conservation criteria.

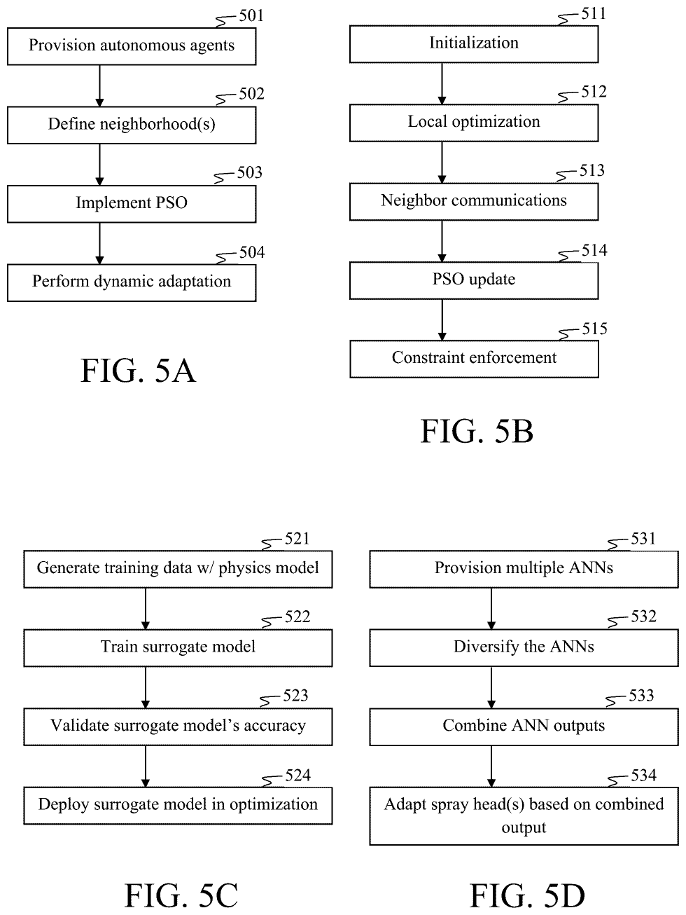

FIG. 5A is a flow chart for implementing a wildfire suppression system in a decentralized manner using PSO or swarm intelligence, which involves distributing decision-making across autonomous fire-suppression devices. Each device can act as an intelligent agent, collaborating with neighbors to optimize a cooling effect at a predetermined location while adhering to water constraints.

Autonomous agents are provisioned 501 in a decentralized architecture, wherein each fire-suppression device (e.g., which includes at least one spray head) may operate as an independent agent (or otherwise has an associated independent agent) that is configured to collect local sensor data, such as windspeed and direction, from nearby sensors. In one example, each device might run a lightweight PSO variant to optimize its droplet size. Each device may include a communication module to share parameters (e.g., droplet size, cooling contribution) with neighboring devices. In alternative aspects, one or more of the agents may reside in hardware and/or software that does not reside in its associated device(s), and the disclosure herein can be adapted to such aspects.

A neighborhood (e.g., 108) can be defined 502 wherein devices communicate with neighbors within a predefined distance or via a network topology (e.g., mesh networks). The neighborhood might be defined via wind conditions, target location(s), a computed path to a target, and/or other criteria described herein. Proximity-based neighborhoods can ensure relevance to shared wind patterns and fire spread dynamics.

PSO implementation 503 can comprise representing each device as a particle that optimizes its own droplet size (and/or other spray head functions described herein). A velocity update can incorporate a local best (p_{best}) that represents the device's historical best droplet size for maximizing cooling, a neighborhood best (n_{best}) that represents the best droplet size among neighbors, which is shared via communication, and optionally, a global awareness wherein top-performing solutions might be distributed across the network. The messages may be lightweight (e.g., JSON packets) to minimize bandwidth use. In some aspects, communication latency can be reduced by prioritizing critical data (e.g., firefront changes) over low-priority updates. Each device might employ a fitness function based on local estimation wherein each device calculates its fitness based on its cooling contribution. The device might use one model or possibly multiple different models (e.g., droplet evaporation rate, wind-driven dispersion) to estimate cooling at the target. Constraints might be employed, such as penalization for droplet sizes that exceed local water reserves or violate shared constraints. A distributed ledger consensus may be used for water budgeting.

In some instances, each agent or device might switch between different model types disclosed herein. In one example, each of a plurality of the agents employs a neural network having very different structure, operating characteristics, speed, and/or internal connection-weights compared to other ones of the plurality of the agents. Disclosed aspects might employ executive decision-making, either within each particle and/or in a centralized processor, that computes a confidence weight for each particles decision. For example, each confidence weight might be based on its particle's error function (or cost function) of estimated cooling and/or the accuracy of the particle's estimated cooling compared to the estimated cooling computed from a physics-based model.

PSO can employ various update rules, such as velocity and position updates. Particles can adjust their positions (droplet sizes) based on their current velocity, their best solution (p_{best}), and the best solution found by the swarm (g_{best}). Inertia weights can be used to control exploration vs. exploitation (e.g., linearly decreasing over iterations). Bounds might be used to enforce minimum/maximum droplet sizes (e.g., 0 to 500 μm). Global constraints might be based on water availability. For example, in a distributed consensus approach, devices might negotiate water usage via gossip protocols or average consensus algorithms. For example, each device might iteratively adjusts its droplet size to ensure the sum of local water usage (across neighbors) stays below regional availability. Agents might reduce their droplet size if local water reserves are depleted, propagating constraints through the network. The network can perform 504 dynamic adaptation, such as in response to the detection of changing wind conditions, changes in fire conditions, and/or updates to water reserves.

FIG. 5B is a flow chart that depicts a wildfire suppression method that employs PSO. In an initialization 511 phase, devices start with random droplet sizes within predetermined bounds. Local optimization 512 comprises each device calculating its cooling contribution using local wind data. Neighbor communications 513 are performed by each device to share p_{best} and n_{best} values with neighboring devices. PSO update 514 comprises adjusting droplet sizes based on p_{best}, n_{best}, and (optionally) water constraints. Constraint enforcement 515 can comprise negotiating water usage via consensus protocols. This process might be re-optimized several times per minute (for example) or when environmental conditions change.

In one example, PSO might be employed for the following velocity update:

$${v}_{i} ( t + 1 ) = w \cdot {v}_{i} ( t ) + {c}_{1} \cdot {r}_{1} ( {p}_{best ( i )} - {x}_{i} ( t ) ) + {c}_{2} \cdot {r}_{2} ( {n}_{best ( i )} - {x}_{i} ( t ) )$$

and position update:

$${x}_{i} ( t + 1 ) = {x}_{i} ( t ) + {v}_{i} ( t + 1 )$$

where the following variables govern how particles (or devices, in the wildfire suppression system) adjust their positions (e.g., droplet sizes) to explore the solution space:

vᵢ(t) is the velocity of particle “i” at iteration “t”, and it represents the momentum of the particle's movement in the search space. Specifically, the velocity indicates how rapidly a device changes its droplet size.

w is the inertia weight, and it can have a value between 0 and 1. The inertia weight controls the influence of the particle's current velocity on its next move. A high w (e.g., 0.9) prioritizes exploration (broad search), whereas a low w (e.g., 0.4) prioritizes exploitation (refining known solutions). The inertia weight typically decreases over iterations to transition from exploration to exploitation.

c₁ is a cognitive coefficient, or individual learning factor, which scales the influence of the particle's best solution (p_{best(i)}). A typical value might be c₁≈2, and it indicates how much a device prioritizes its own historical best droplet size.

r₁ is a random number uniformly distributed between 0 and 1, which introduces stochasticity to prevent premature convergence. For example, if r₁=0.5, the cognitive term (c₁r₁) is halved, reducing reliance on past success.

The value (p_{best(i)}−xᵢ(t)) is the difference between the particle's best position (p_{best(i)}) and its current position (xᵢ(t)). This term pulls the particle toward its own best-known solution, which means that it guides a device to replicate droplet sizes that previously maximized cooling at the target.

c₂ is a social coefficient, or collective learning factor, which scales the influence of the neighborhood best solution (n_{best(i)}). A typical value might be c₁≈2, and it indicates how much a device prioritizes solutions from neighboring devices.

r₂ is a random number uniformly distributed between 0 and 1, which adds randomness to the social component, (n_{best(i)}−xᵢ(t)).

The value (n_{best(i)}−xᵢ(t)) is the difference between the best position (n_{best(i)}) in the neighborhood and the particle's current position (xᵢ(t)). This term pulls the particle toward the best solution found by its neighbors, which encourages devices to align with optimal droplet sizes used by nearby devices (e.g., coordinating to cover overlapping fire zones).

By tuning these variables, the system balances individual device performance, neighborhood collaboration, and adaptability to changing wildfire conditions. Disclosed aspects might employ any of various adaptations to configure exploration and exploitation, such as provisioning a high value of w for global search or a low value of w for local refinement; and/or provisioning a relationship between individual and social learning (e.g., via selection of c₁,c₂). Stochasticity can be introduced (e.g., via r₁, r₂) to provision diversity in the solutions. Disclosed aspects can employ any of various decentralized adaptation algorithms to enable devices to self-organize without central coordination, such as demonstrated by the determination of n_{best(i)} with the aid of local communications between neighboring devices.

Accordingly, disclosed decentralized swarm intelligence approaches can enable wildfire suppression system to self-organize, adapt dynamically, and optimize resource usage without centralized control. By leveraging local interactions and lightweight PSO variants, devices can collaboratively maximize cooling while adhering to global constraints. In some aspects, edge computing might be employed using Raspberry Pi/Arduino controllers on devices. Distributed algorithms, such as federated learning frameworks or blockchain, may be employed. Transceivers might employ any of various short-range, cellular, or fixed wireless access protocols, including (but not limited to) LoRaWAN, Zigbee, 802.11, or 5G.

FIG. 5C is a flow chart that depicts a wildfire suppression method that employs a surrogate model as a supplement to, or in place of, a physics model for estimating and/or predicting cooling effects for different wildfire suppression strategies. Physics-based models (e.g., computational fluid dynamics for droplet dispersion, evaporation, and cooling) are accurate but can be computationally expensive, such as for run-time operations. Surrogate models can approximate physics-based models with minimal loss of accuracy, but with significantly faster computation, enabling real-time optimization in systems, such as PSO.

In a data-generation 521 phase, the physics model can be run to generate input-output dataset pairs for training the surrogate model. A physics-based model can be run across a wide range of scenarios to create the training data. The input to the physics model can include parameters that affect cooling (e.g., droplet size, wind speed/direction, device location), and the output calculated by the physics model can include the cooling effect at the target location. In one example, thousands of combinations of droplet sizes and wind vectors are simulated to map to cooling values.

A training 522 phase can comprise provisioning the surrogate model for training. Neural networks are a good choice for modeling nonlinear relationships (e.g., cooling as a function of wind and droplet dynamics). In one example, a feedforward architecture with 3-5 hidden layers might be implemented wherein ReLU activation functions are employed for hidden layers, and linear functions for the output layer. TensorFlow, PyTorch, or scikit-learn might be used for model training. Any of various alternative neural network architectures and/or configurations might be used. Alternatives, such as Gaussian Processes or Random Forests might be employed.

In one aspect, training 522 the surrogate model might comprise preprocessing the data, such as normalizing inputs and/or output to a predetermined scale (e.g., [0,1]). A loss function, such as mean squared error (MSE) between predictions and physics-model outputs, can be provisioned. Gradient descent or other learning functions can be used to adapt model parameters to minimize the loss function. The training data might be split into training (e.g., 80%) and validation (e.g., 20%) sets to prevent overfitting. Training 522 might comprise hyperparameter tuning, such as to optimize learning rate, layers, and/or batch size, such as via grid search or Bayesian optimization.

A validation 523 phase can be conducted to validate the accuracy of the surrogate model. For example, the physics model might be run periodically (or responsive to various criteria) and compared to the surrogate model. In some aspects, the physics model might be run sparingly to refine surrogate predictions. The surrogate model can be retrained using data from the physics model, such as when wind patterns or other conditions change.

Various metrics, such as R² Score, might be employed to measure how well predictions match the physics model outputs. A Mean Absolute Error characterizes the absolute difference between predictions and ground truth.

The surrogate model might be deployed 524 in an optimization loop. Neural networks can be implemented with TensorFlow Lite or ONNX for operating on edge devices. Some disclosed aspects might provide for replacing a physics model with the surrogate model in a PSO fitness function. In one aspect, the surrogate model might be integrated into the PSO workflow by training the surrogate model offline using historical/simulated data and then using the surrogate to evaluate cooling effects during PSO iterations. Surrogate model operations can be refined by validating critical solutions with the physics model. Semi-supervised or unsupervised learning might be performed. In active learning scenarios, libraries, such as modAL might be used to prioritize simulations in under-sampled regions. In some aspects, the operation of the surrogate model might be augmented with the physics model.

While it can be computationally infeasible to rely entirely on physics-based models at run-time, physics-based models might be used intermittently or periodically during run-time, such as to validate the results of the surrogate model. In some instances, the validation might comprise measuring the accuracy of the surrogate model and/or might comprise a confidence measure, and such validations might be used to control how often the physics-based model is employed, such as to increase the frequency of physics-model use when the accuracy or confidence falls below a predetermined threshold, or to decrease the frequency of physics-model use when the accuracy or confidence rises above a predetermined threshold.

FIG. 5D illustrates methods and apparatus implementations according to some disclosed aspects. Multiple artificial neural networks (ANNs) can be provisioned 531 to operate spray heads in a geographically distributed fire-suppression network. For example, each of the ANNs might be adapted to select spray head control parameters that adjust the spray pattern produced by each spray head. The ANNs might select droplet size, possibly among other spray pattern features, based on at least input wind data. Provisioning 531 the ANNs might comprise selecting certain ones of the spray heads to activate and/or selecting certain ones of the ANNs to employ. Provisioning 531 might comprise configuring the ANNs to provide for PSO, such as disclosed herein.

Diversifying 532 the ANNs can comprise providing the ANNs with different structures and/or operating characteristics. For example, different structures might include different network architectures. One ANN might be a feedforward neural network, another might be a recurrent neural network, another might be a convolutional neural network, another might be a generative adversarial neural network, and/or another might be a transformer. Different ANNs might employ different layer types, such as dense (fully connected) layers, locally connected layers, sparse layers, convolutional layers (which might employ filters/kernels to detect spatial patterns), pooling layers, recurrent layers (e.g., Long Short-Term Memory (LSTM) or Gated Recurrent Unit (GRU)), and/or attention layers. ANNs might differ from each other in depth (e.g., number of layers) and/or width (number of nodes in each layer). ANNs might differ from each other by the activation functions they employ (e.g., sigmoid, Tanh, ReLu, leaky ReLu, softmax, etc.). ANNs might differ from each other by the learning strategies they employ. Learning strategies might include backpropagation, reinforcement learning, or contrastive learning. Diversifying 532 might be configured to provide a selection of ANNs that have uncorrelated failure modes. Diversifying 532 might be performed with provisioning 531 the ANNs.

An executive function can be provided 533 for combining ANN outputs, or decisions (e.g., classifications), to arrive at a final or consensus decision. For example, cach ANN output might comprise a corresponding confidence measure. The executive process can monitor ANN confidence levels and compute an aggregate or combined confidence level for a candidate decision. When this aggregate or combined confidence is low, the executive process can continue to collect more information until the aggregate or combined confidence is above a threshold value. Diversifying 532 might comprise providing ANNs with different amounts of time to arrive at a decision. One possible implementation is a cascading system in which inexpensive, fast neural networks make rough assessments of the data and slower, more precise neural networks (and/or physics-based models, and/or sensors) make successively more refined assessments, until at some point the executive function issues a response. The response might comprise an estimated cooling effect and/or a selected droplet size.

The executive function 533 might employ context awareness, such as by identifying regions of input data (e.g., data that is indicative of wind and/or fire conditions) where ANNs in general might be more or less accurate, or where certain types of ANNs (e.g., with different structures and/or operating characteristics) are more or less accurate. In some aspects, the executive function 533 might employ context awareness to provide for influence or control over provisioning 531 and/or diversifying 532. In a region where a particular type of ANN is more reliable, the executive function might provide that type of ANN with a higher weight, whereas less-reliable ANNs in that region might be provided with a lower weight, or excluded from decision-making. Since the ANNs can provide cooperative and competing decisions, the executive function 533 might be configured to mitigate competition in its decision.

The executive function 533 might be centralized or decentralized. In a decentralized implementation, each ANN might comprise its own executive function 533. In some instances, each of a set of decentralized executive functions 533 defines its neighborhood (e.g., 108) to maximize diversity 532 of ANNs, and possibly based on any of the other neighborhood selection techniques disclosed herein.

Based on the combined output, the executive function might adjust 534 one or more spray heads to improve cooling at one or more target locations. For example, adjusting the operation of each spray head can adapt the spray (e.g., height, direction, range, droplet size, and/or other features) to increase cooling at the one or more target locations. Based on the combined output and the location of sensors, the executive function might adapt and/or select sensors, and/or otherwise adapt inputs to the ANNs. The intent here can be to filter the data inputs to the ANNs in a manner that improves the accuracy of their decisions.

In a real-time environment such as an active wildfire, the executive function 533 might combine outputs from multiple ANNs and possibly other decision-making sub-components, and might further be configured to balance accuracy with urgency. Given that wildfires evolve rapidly, decisions on fire suppression must be made within constrained time frames, even if not all desired data has been fully processed. Thus, the executive function 533 can be configured to manage a trade-off between computational depth and timely action.

In disclosed aspects, the executive function 533 can aggregate ANN outputs (each possibly accompanied by a confidence measure) and determine when to issue a decision. The deadline for decision-making can be defined in different ways. The system might employ a predefined time window (e.g., every few seconds) within which it must determine an optimal droplet size and/or cooling effect estimate. Some deadlines might be tied to events. A deadline might be defined by the fire-front reaching a designated boundary, requiring immediate action before conditions worsen; a sudden change in wind direction that necessitates a recalibration of spray patterns; or a command from a human firefighter, prompting the system to execute an immediate suppression strategy.

To optimize responsiveness, the executive function 533 might implement a cascading decision architecture. For example, fast, low-precision ANNs can be employed for making initial rough assessments, providing quick but less accurate estimations. Slower, high-precision ANNs, physics-based models, and/or collected sensor data can refine these estimations, if time permits. Adaptive decision thresholds might ensure that if confidence is high enough early on, the system can act without waiting for deeper processing. If time runs out before all sub-components have contributed, the executive function 533 might select the best available estimate at that moment. This ensures that real-time constraints do not delay life-saving suppression actions. By integrating multi-level processing with deadline-driven decision-making, the executive function 533 maximizes both accuracy and responsiveness, ensuring that suppression efforts are based on the best available intelligence while meeting the urgent demands of wildfire response.

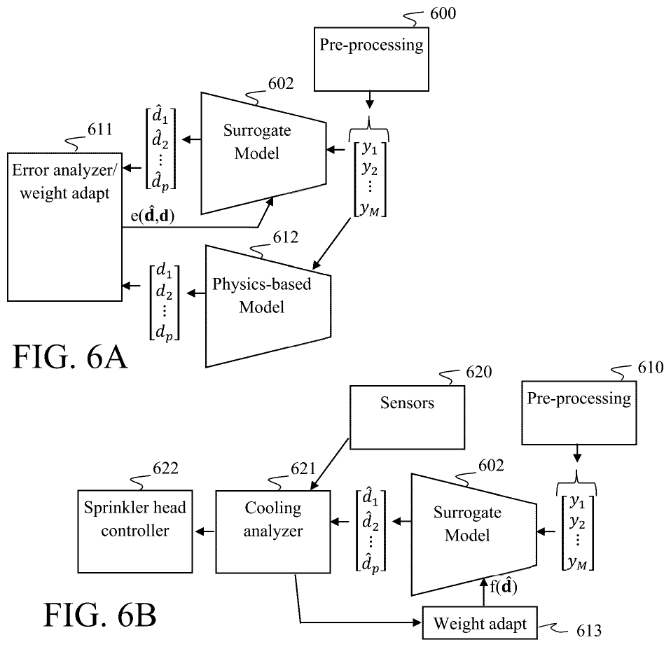

FIG. 6A illustrates functional aspects of an apparatus configured to operate according to some aspects of the disclosure. Various data sets, which can comprise any combination of computed data and sensor data, is pre-processed 600 to produce data inputs to a surrogate model (e.g., a neural network) 602 and a physics-based model 612. The input (vectors y) to each model 602 and 612 can include parameters that affect cooling (e.g., droplet size, wind speed/direction, device location, target location, etc.), and the output calculated by each model 602 and 612 can include the cooling effect at the target location. In some instances, the physics-based model 612 might be implemented before processing of the input (vectors y) by the surrogate model 602.

The physics model 612 generates ground truth output data (e.g., ground truth vectors d) and the surrogate model 602 generates predicted output data (e.g., prediction vectors \hat{d}). An error analyzer 611 determines an error or cost function from the predicted and ground-truth data, and computes a parameter update (e.g., e(\hat{d},d)) for the surrogate model 602. Through training, the surrogate model 602 learns to generate outputs that closely resemble the ground truths produced by the physics model 612. It should be appreciated that in some aspects, the physics model 612 may be augmented or replaced by sensor data, such as data produced by thermal imaging, thermometers, fire detectors, smoke detectors, and/or other environmental sensors, imagers, or cameras.

FIG. 6B illustrates functional aspects of an apparatus configured to operate according to some aspects of the disclosure wherein the surrogate model 602 is already trained, such as described above with respect to FIG. 6A. The surrogate model 602 might be configured to determine droplet size, and possibly other fire-suppression parameters, based on the input parameters (e.g., vectors y) produced by preprocessing 610, such as wind speed/direction, device location, target location, etc.). The output (e.g., prediction vectors \hat{d}) calculated by the model 602 can include at least a predicted droplet size. Various different aspects may be used to update the model's (e.g., model 602) network parameters to find the optimal droplet size (possibly in combination with one or more other fire-suppression strategies) that maximizes the cooling effect at a target location. The droplet size (and possibly other spray head operating features disclosed herein) in the prediction can be converted to spray head control parameters in a spray head controller 622, which configures each spray head to produce a corresponding droplet size (and possibly other spray characteristics disclosed herein).

In one aspect, a cooling analyzer 621 might be provisioned to evaluate the cooling effect at the target location based on sensor data collected from one or more fire-detection sensors 620. The cooling analyzer 621 might compute cooling gradients, which are at least a function of droplet size, and might configure a parameter update 613 (e.g., f(\hat{d})) to tune the surrogate model 602 to compute one or more droplet sizes that improve cooling. Thus, cooling-effect feedback resulting from spray head control 622 can be used to adapt the surrogate model 602.

In one aspect, a neural network (e.g., surrogate model 602) is configured to adapt its network parameters, wherein the network parameters provide for provisioning a set of control signals in a distributed fire-suppression system. The network parameters might be configured to produce a set of expectation values (e.g., in this case, \hat{d}) for sensor measurements. The neural network can be configured to generate an error estimate (e.g., this may be represented by f(\hat{d})) as a function of the expectation values and measured sensor values. For example, this might be implemented by the cooling analyzer 621. The neural network can be configured to update its network parameters (e.g., via parameter update 613) in a manner that reduces the error estimate. In a concurrent aspect, or in a different aspect, the network parameters are adapted to effect a predetermined set of measured sensor values.

In a different aspect, the surrogate model 602 might estimate the cooling effect for different droplet sizes (possibly in combination with one or more other fire-suppression strategies) and adapt 613 its own network parameters (and possibly hyperparameters) to determine a droplet size that achieves an optimal or otherwise suitable cooling effect. In this case, the droplet size (e.g., prediction vectors \hat{d}) may be coupled directly to the spray head controller 622, and sensors 620 and cooling analyzer 621 may or may not be implemented.

In another aspect, the surrogate model 602 might comprise a first neural network and a second neural network. The first neural network is trained to predict a cooling effect corresponding to input data, wherein the input data comprises sprayer control parameters (e.g., droplet size) in a distributed fire-suppression system. Upon training the first neural network, the second neural network might be trained for adapting the sprayer control parameters (e.g., droplet size) in the input data to the first neural network; wherein adapting comprises updating the second neural network's network parameters in a manner that improves the cooling effect predicted by the first neural network.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” or “at least one of: a, b, and c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. 112, sixth paragraph, unless the element is expressly recited using the phrase “means for” or, in the case of a method claim, the element is recited using the phrase “step for.”

1. A method, comprising:
collecting wind data from a plurality of wind sensors;
using the wind data and each of a set of different droplet sizes, computing a set of cooling effect contours of a spray that would be produced by a spray head;
selecting a one of the set of cooling effect contours that produces an optimal cooling effect at a target location; and
configuring the spray head to produce a one of the set of different droplet sizes that corresponds with the one of the set of cooling effect contours.

2. The method of claim 1, further comprising:
selecting a set of wind sensors along a path from the spray head to the target geographical location;
aggregating the wind data from the set of wind sensors to model windspeed and direction along the path to compute a wind-path vector; and
based on the wind-path vector, computing an optimal droplet size that provides the optimal cooling effect;
wherein configuring the spray head comprises adjusting the spray head to produce the optimal droplet size.

3. The method of claim 1, wherein computing and selecting are configured to be performed in a central processor or in a distributed set of processors.

4. The method of claim 1, wherein collecting wind data and configuring the spray head comprises provisioning a communication network topology in response to a fire event.

5. The method of claim 1, wherein configuring the spray head further comprises adjusting at least one of the spray head's elevation angle, azimuth angle, fluid pressure, or spray pattern.

6. The method of claim 1, wherein at least one of computing a set of cooling effect contours or selecting the one of the set of cooling effect contours is performed within a constraint based on water availability or water conservation criteria.

7. A method, comprising:
provisioning a plurality of independent agents, each of the plurality of independent agents associated with a fire-suppression device and configured to operate as a particle in a particle swarm optimization (PSO) implementation;
defining at least one neighborhood, each neighborhood comprising multiple ones of the plurality of independent agents;
provisioning communication between the multiple ones of the plurality of independent agents; and
configuring each particle to optimize a droplet size to maximize cooling at a target location, the droplet size being a function of the each particle's historical droplet size and at least one droplet size determined by at least one neighboring particle.

8. The method of claim 7, wherein defining the at least one neighborhood is based on distance from at least one spray head, wind sensor, or fire sensor.

9. The method of claim 7, wherein the at least one neighborhood is determined using wind data.

10. The method of claim 7, wherein provisioning communication configures a communication network topology in response to a fire event.

11. The method of claim 7, wherein provisioning communication comprises configuring a mesh network.

12. The method of claim 7, wherein provisioning the plurality of independent agents comprises diversifying the plurality of independent agents.

13. The method of claim 7, wherein configuring each particle to optimize the droplet size comprises supplementing a surrogate model with results from at least one of a physics-based model and sensor data.

14. A method, comprising:
training at least a first neural network to predict a cooling effect for input data comprising spray head control parameters in a distributed fire-suppression system; and
training at least a second neural network for adapting the input data to the at least first neural network; wherein adapting comprises updating the at least second neural network's network parameters in a manner that produces adapted input data that improves the cooling effect predicted by the at least first neural network.

15. The method of claim 14, wherein the at least first neural network is a particle in a particle swarm optimization (PSO) implementation or the at least second neural network is a particle in an other PSO implementation.

16. The method of claim 14, wherein training the at least first neural network comprises employing at least one of a physics-based model, an executive system's output, or sensor data to provide ground truths.

17. The method of claim 14, further comprising converting the adapted input data to spray head control parameters that adjust the spray head to improve the cooling effect.

18. The method of claim 14, wherein the at least first neural network comprises a first plurality of artificial neural networks (ANNs) and a first executive function that combines outputs from the first plurality of ANNs, or wherein the at least second neural network comprises a second plurality of ANNs and a second executive function that combines outputs from the second plurality of ANNs.

19. The method of claim 18, wherein the first executive function or the second executive function employs a cascading decision architecture.

20. The method of claim 18, wherein the first executive function or the second executive function employs adaptive decision thresholds.
